(19) United States
(12) Patent Application Publication
(10) Pub. No.: US 2011/0180527 A1
(43) Pub. Date: Jul. 28, 2011

(54) ELECTRIC GRILL AND METHODS OF PROVIDING THE SAME

(75) Inventor: Richard C. ABBOTT, Boucherville (CA)

(73) Assignee: THERMOCERAMIX INC., Boucherville (CA)

(21) Appl. No.: 12/908,013

(22) Filed: Oct. 20, 2010

Related U.S. Application Data
(63) Continuation-in-part of application No. 11/474,650, filed on Jun. 26, 2006, now Pat. No. 7,834,296.
(60) Provisional application No. 60/693,609, filed on Jun. 24, 2005.

(51) Int. Cl. H05B 3/68; H01C 17/02; A47J 37/00; B23P 19/00

(52) U.S. Cl. 219/450.1; 29/611; 29/700; 126/25 R; 29/428

(57) ABSTRACT

An electric grill is provided having a grate, a first electrical insulator layer located above the grate, a heater layer deposited on a top surface of the first electrical insulator layer, and a top layer located over the heater layer for protecting the heater layer.

### CROSS-REFERENCE TO RELATED APPLICATIONS

This application is a continuation-in-part of U.S. patent application Ser. No. 11/474,650, filed on Jun. 26, 2006, now U.S. Pat. No. ______, which claims the benefit of U.S. Provisional Application No. 60/693,609, filed on Jun. 24, 2005, the entire teachings of which are incorporated herein by reference.

### FIELD OF THE INVENTION

The present invention is generally related to cooking devices, and more particularly is related to an electric grill.

### BACKGROUND OF THE INVENTION

Grills often use a heat source. Examples of such heat sources include combustible gas, such as propane, or solid fuel, such as charcoal. However, fire codes often prohibit grilling with open flames that gases or charcoal produce and users often prefer not working with open flames. In addition, refilling tanks holding the combustible gas, and purchasing solid fuel, can be inconvenient and expensive.

To address the above-mentioned issues, electric grills have been introduced. Electric grills alleviate the need for open flames, thereby alleviating the expense and inconvenience. Moreover, they comply with fire code regulations. Unfortunately, electric grills use wire type tubular elements that are too inefficient at a common household voltage of 120 volts to provide adequate temperatures for searing meat over reasonably sized cooking areas. Specifically, the inefficiency of electric grills prevents an electric grill from achieving the elevated temperatures necessary for performing cooking functions such as searing meat and from recovering back to cooking temperature after food has been distributed over the grilling surface. Thus, a heretofore unaddressed need exists in the industry to address the aforementioned deficiencies and inadequacies.

### SUMMARY OF THE INVENTION

Embodiments of the present invention provide a system for providing an electric grill. In principle, a grill will heat primarily by thermal conduction or primarily by thermal radiation. This invention describes systems that utilize thin, film type electrical resistive heating elements that generate and transfer heat to the food either principally by conduction or principally by radiation.

When thermal conduction is the primary mode of heat transfer, the film element can be disposed over a surface of the grill either on top of the grilling surface or on the underside of the grilling surface. Heat is generated by passing an electrical current through the resistive film heating element whereupon the heat is conducted directly to the food if the element is on the top surface of the grill or through the metal grilling surface and then to the food if the element is on the bottom surface of the grill.

When thermal radiation is the primary mode of heat transfer, the film element can be disposed over a surface positioned either below the grilling surface or above the grilling surface. Here, electrical current passes through the film heating element such that the substrate upon which the element is deposited heats to a temperature sufficiently high for thermal radiation to be emitted in sufficient intensity to heat the food to the desired cooking temperature.

Briefly described, in architecture, one embodiment of the system, among others, can be implemented as follows. The electric grill has a grate, a first electrical insulator layer located above the grate, a heater layer deposited on a top surface of the first electrical insulator layer, and a top layer located over the heater layer for protecting the heater layer.

In other aspects, an electric grill and methods for fabricating an electric grill include a film heater layer that can be formed, for example, by depositing a film of resistive material using thermal-spray, kinetic spray, thick film deposition, evaporation, chemically vapor deposition, laser cladding, sputtering, pulsed laser deposition, cathodic arc deposition, and Physical Vapor Deposition (this is a common way to refer to a number of the above methods).

A film heater layer (also referred to herein as heater layer) can be provided, for example, on a heat shield, on a support tray for ceramic briquettes or the like, or on a heater panel suspended from the hood of the grill.

In one embodiment, an electric grill comprises a shaped metal sheet, that can be formed by stamp pressing, for example, to provide a grill having a plurality of raised ridges. A plurality of heater layers can be provided on the raised ridges and connected in parallel by a pair of conductive traces.

In yet another aspect, a grill includes an odor-reducing device having a heater layer.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Other features and advantages of the present invention will be apparent from the following detailed description of the invention, taken in conjunction with the accompanying drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating an example of an electric grill, in accordance with a first exemplary embodiment of the invention;

FIG. 2A is a schematic diagram illustrating an example of an electric grill, in accordance with a second exemplary embodiment of the invention;

FIG. 2B is a schematic diagram further illustrating a grate located within the electric grill of FIG. 2A;

FIG. 3 is a schematic diagram illustrating a variation of the electric grill of FIG. 1;

FIG. 4 is a schematic diagram illustrating an electric grill, in accordance with a third exemplary embodiment of the invention;

FIG. 5 is a schematic diagram illustrating an electric grill, in accordance with a fourth exemplary embodiment of the invention;

FIG. 6 is a schematic diagram illustrating an electric grill according to a fifth embodiment of the present invention;

FIG. 7 is a cross-section view of the electric grill of FIG. 6 illustrating a plurality of ridges separated by open spaces;

FIG. 8 is a schematic diagram illustrating the underside of the electric grill of FIG. 6;

FIG. 9 is a schematic illustration of a method of providing an electric grill;

FIG. 10 is a schematic diagram illustrating an electric grill according to a sixth embodiment of the present invention;

FIG. 11 is a schematic diagram illustrating an electric grill according to a seventh embodiment of the present invention; and

FIG. 12 is a schematic diagram illustrating an electric grill with an odor-removal device according to an eighth embodiment of the present invention.

FIG. 13 is a schematic diagram illustrating an electric grill with an odor-removal device combined with a heat exchanger according to a ninth embodiment of the present invention.

FIG. 14 is a schematic diagram illustrating an electric grill with an odor-removal device combined with a heat exchanger and a re-circulator according to a tenth embodiment of the present invention.

### DETAILED DESCRIPTION OF THE PREFERRED EMBODIMENTS

The present invention provides an electric grill, or barbeque, that uses electric resistive heaters (referred to as “heater layers”) in the form of coatings as a heat source. A power source may be connected to the heater layer to provide power to the heater layer, resulting in the resistive heater radiating energy (i.e., heating). An example of a process for making a resistive heater is described in the U.S. Pat. No. 6,919,543, assigned to ThermoCeramix, Inc., issued Jul. 19, 2005, and having been filed Nov. 28, 2001, the disclosure of which is incorporated herein in its entirety.

The electric grill contains a supporting structure for holding food thereon (i.e., a grate), means for draining grease or any other liquid that comes from food cooking on the electric grill, and a heater layer. In accordance with the present invention, the heater may be provided as, for example, but not limited to, a coating.

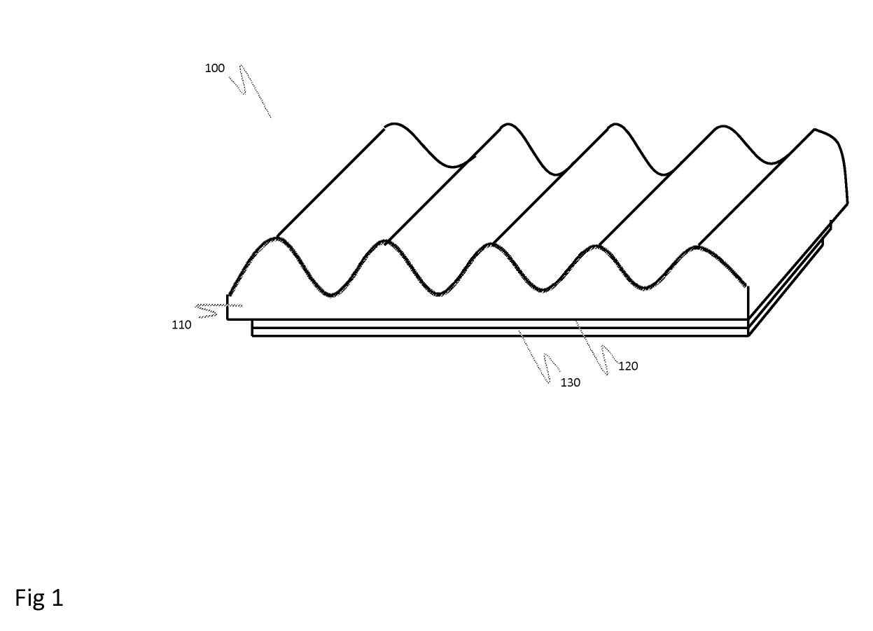

FIG. 1 is a schematic diagram illustrating an example of an electric grill 100, in accordance with a first exemplary embodiment of the invention. As is shown by FIG. 1, the electric grill 100 contains a solid casting grate 110 on which food to be cooked is placed. An example of material that may be used for the solid casting grate 110 is aluminum. Of course, other known conductive materials such as cast iron, carbon steel or stainless steel may be used as well. An electrical insulator layer 120 (e.g., an electrical insulator coating) is located on a bottom portion of the solid casting grate 110. In addition, a film heater layer 130 (e.g., a heater coating) is deposited on a bottom portion of the electrical insulator layer 120, on a portion opposite the solid casting grate 110. In accordance with the first exemplary embodiment of the invention, heat flows virtually unimpeded up from the heater layer 130, through the electrical insulator layer 120, to the solid casting grate 110. Of course, the solid casting grate 110 may be replaced by a casting grate that is not solid or simply shaped differently.

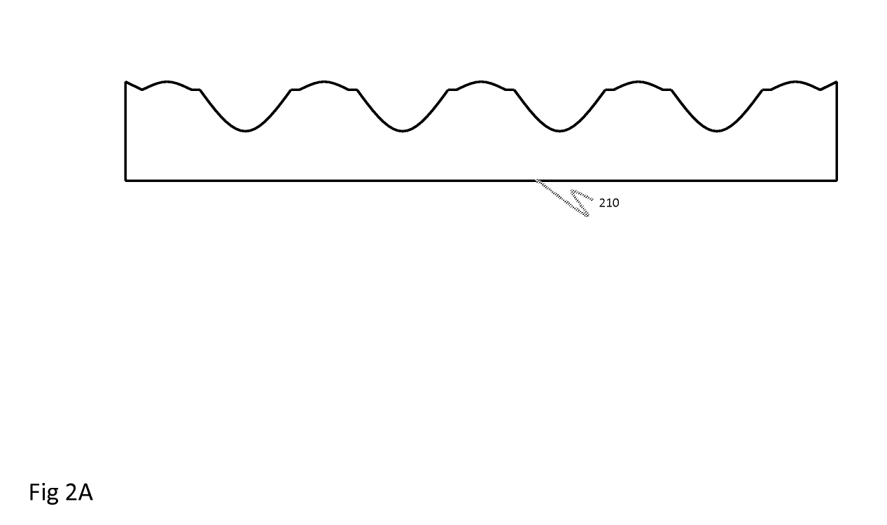

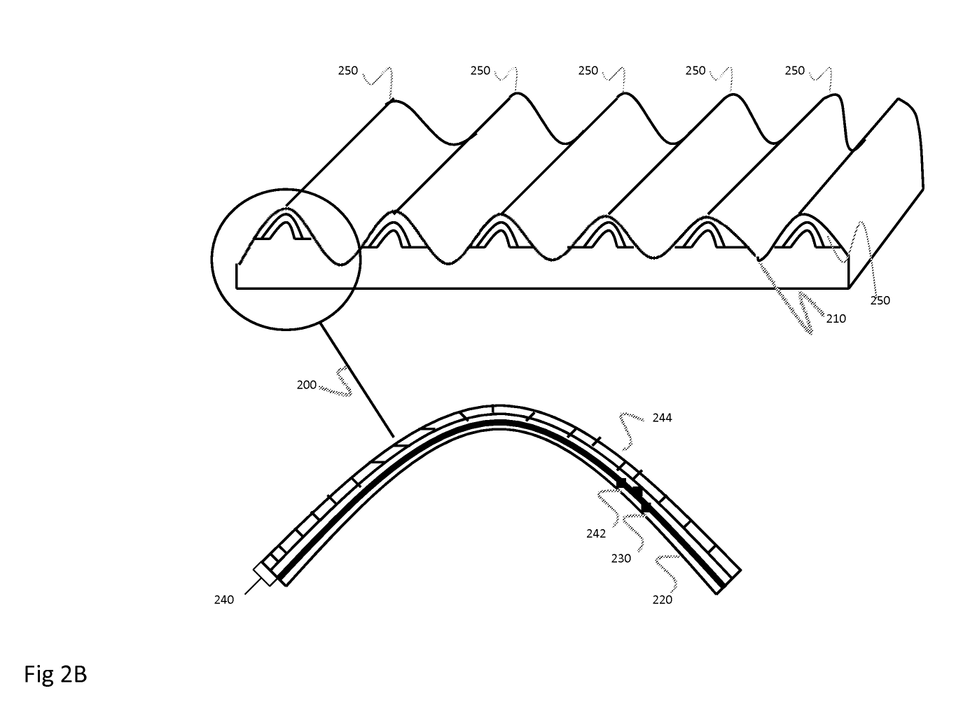

FIG. 2A is a schematic diagram illustrating an example of an electric grill 200 in accordance with a second exemplary embodiment of the invention. As is shown by FIG. 2B, the electric grill 200 contains a solid casting grate 210. FIG. 2B is a schematic diagram further illustrating the grate 210 without having layers deposited thereon, as is further explained herein.

Returning to FIG. 2A, it can be seen that the grate 210 contains a series of ridges 250, which are raised portions of the grate 210. Other portions of the grate 210 are concave in shape. A first electrical insulator layer 220 (e.g., an electrical insulator coating) is located between the grate 210 and a heater layer 230 (e.g., a heater coating), where the film heater layer 230 is deposited on a top surface of the first electrical insulator layer 220. Specifically, the first electrical insulating layer 220 is located on a top surface of the grate 210. In addition, the film heater layer 230 is located on a top surface of the first electrical insulating layer 220.

A top layer 240 is provided on a top surface of the heater layer 230 and may be provided as a coating or otherwise on the heater layer 230. The top layer 240 serves to protect the heater layer 230 from grease, other substances, and abuse. It should be noted that the top layer 240 may contain either a second electrical insulator layer 242 (e.g., a ceramic insulator), or a second electrical insulator layer 242 (e.g., ceramic insulator) and a metal layer 244 located on top of the second electrical insulator layer 242. It should be noted that the top layer 240 prevents the user of the electric grill 200 from being exposed to electrical hazard.

The exemplary electric grill 200 of FIG. 2A shows that the first electrical insulator layer 220, the heater layer 230, and the top layer 240 are located within each ridge 250 of the electric grill 200. Therefore, there are a number of groups of the above-mentioned components, where each group is located beneath a ridge 250. Alternatively, the entire solid casting grate 210 may be covered with one first electrical insulator layer 220, one heater layer 230, and one top layer 240 (not shown).

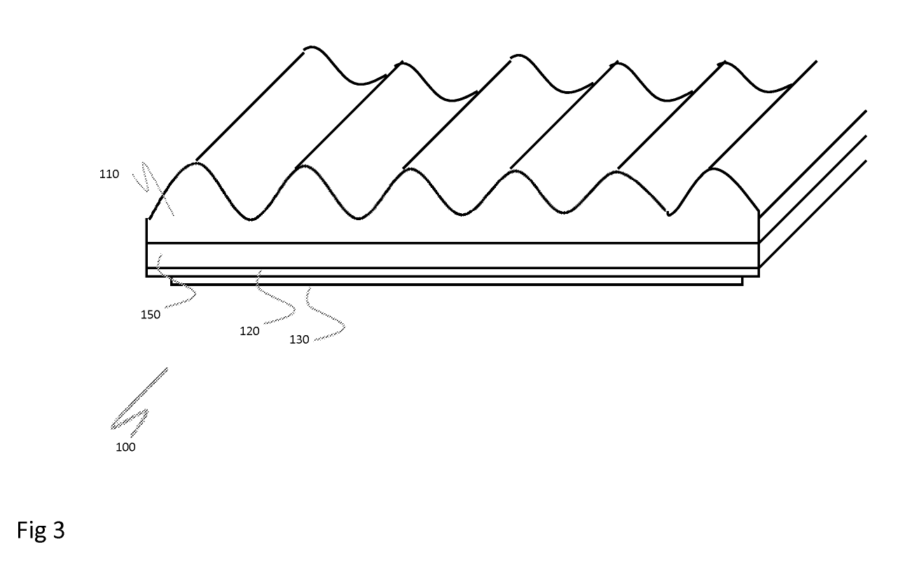

FIG. 3 is a schematic diagram illustrating a variation of the electric grill 100 of FIG. 1. Specifically, the electric grill 100 also contains a heater plate 150 located between the electrical insulator layer 120 (e.g., an electrical insulator coating) and the bottom portion of the solid casting grate 110. The heater plate 150 is capable of conducting heat (i.e., receiving energy) from the heater layer 130 and transferring the heat to the solid casting grate 110. It should be noted that the heater plate 150 may be removably connected to the solid casting grate 110 and/or the electrical insulator layer 120. Alternatively, the solid casting grate 110 may simply rest on the heater plate 150. In addition, in accordance with another alternative embodiment of the invention, the heater plate 150 may contain the heater layer 130 therein.

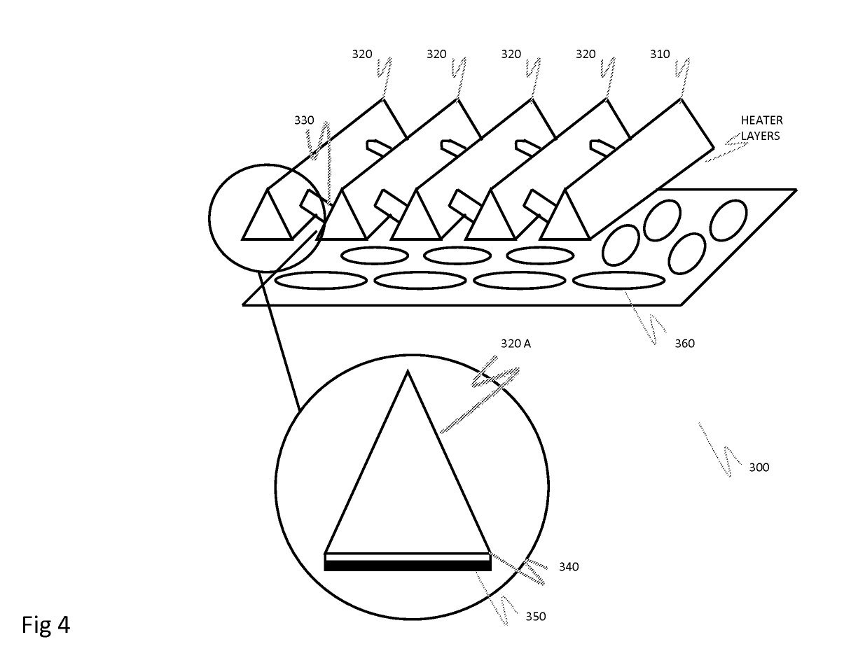

FIG. 4 is a schematic diagram illustrating an electric grill 300 in accordance with a third exemplary embodiment of the invention. As is shown by FIG. 4, the electric grill 300 has a grate 310 having a different design from the grate 110 of FIG. 1. Specifically, the grate 310, in accordance with the third exemplary embodiment of the invention, contains a series of shaped rods 320 having connecting bars 330 connecting the shaped rods 320. Describing one shaped rod 320A, each shaped rod 320A has an electrical insulator layer 340 located on a bottom surface of the shaped rod 320A and a heater layer 350 located beneath the electrical insulator layer 340. It should be noted that ceramic tiles 360 may be positioned below the grate 310 for evaporating grease and other secretions from food being cooked on the electric grill 300. In addition, while FIG. 4 illustrates each shaped rod 320 as being triangular in shape, one having ordinary skill in the art would appreciate that the shaped rods 320 may be shaped differently.

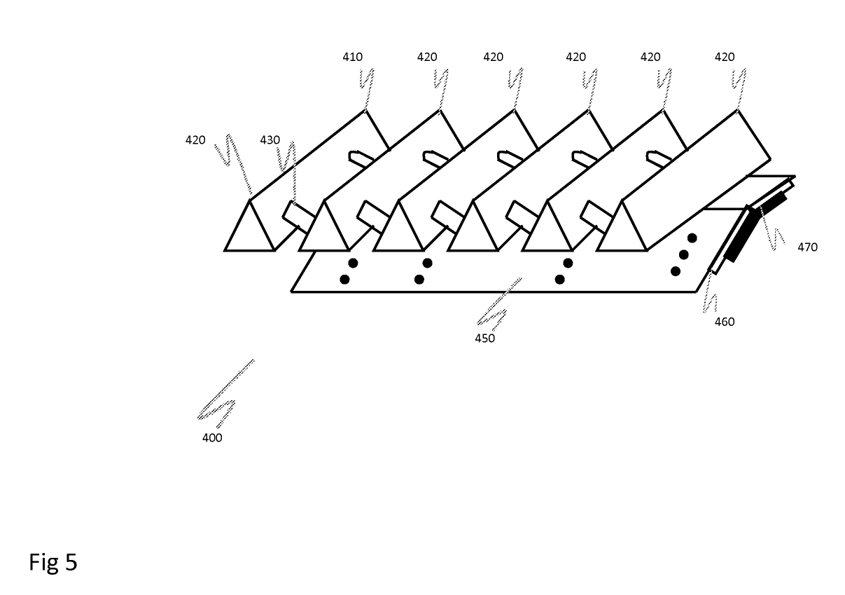

FIG. 5 is a schematic diagram illustrating an electric grill 400, in accordance with a fourth exemplary embodiment of the invention. As shown by FIG. 5, the electric grill 400 has a grate 410 having a different design from the grate 110 of FIG. 1. Specifically, the grate 410, in accordance with the fourth exemplary embodiment of the invention, contains a series of shaped rods 420 having connecting bars 430 connecting the shaped rods 420. A heating plate 450 may be positioned below the grate 410 for purposes of radiating energy (i.e., providing heat) up to food positioned on the grate 410. The heating plate 450 may be shaped and sized many different ways for purposes of radiating heat. An electrical insulator layer 460 is located below the heating plate 450 and a heater layer 470 is located beneath the electrical insulator layer 460.

The heating plate 450 can be in the form of a heat shield. Heat shields are commonly used in gas grills and are located between the gas burner and the cooking grate. The heat shield protects the burner from corrosive drippings, helps to disperse the heat more evenly across the surface of the grill, and can vaporize drippings to infuse the food with additional flavor. A conventional gas grill can be easily retrofitted into an electric grill by providing the layered heating element of the present invention on a heat shield, such as shown in FIG. 5.

Alternatively, the heating plate for 450, electrical insulator layer 460, and heater layer 470 may be located separate from the grate 410. As one example, the heating plate 450, electrical insulator layer 460, and heater layer 470 may be located above the grate 410, such as on a hood of a barbecue grill, or on a shelf like structure they can be positioned above food resting on the grate 410. In such an arrangement, energy radiates down to the food. Such a configuration would be ideal for broiling food resting on the grate 410.

The heater layers or film heater layers mentioned above are preferably provided as coatings, although other methods may be used for providing the heater layers. As coatings, the heater layers can be made using many different coating technologies. Performance of the coatings depends on materials chosen for the resistor, the dimensions of the element, and the method by which the coating is deposited. Examples of coating techniques include, but are not limited to: thermal spray, an example of which is described by U.S. Pat. No. 6,919,543, which has been incorporated by reference in its entirety; kinetic or cold spray, an example of which is described by U.S. provisional application No. 61/353,977, which has been incorporated by reference in its entirety; thick film deposition, evaporation, chemically vapor deposition, laser cladding, sputtering, pulsed laser deposition, cathodic arc deposition, PVD materials.

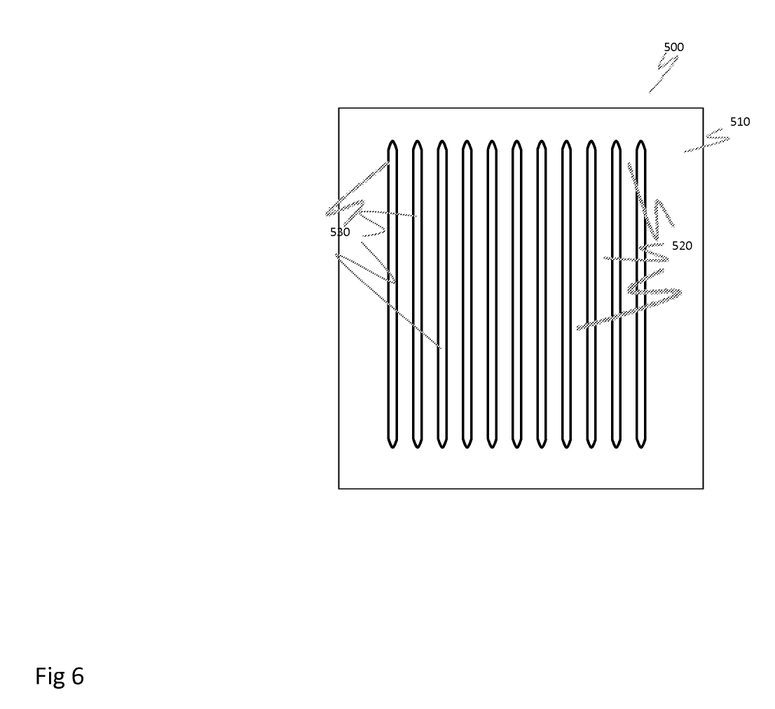

FIG. 6 is a schematic diagram illustrating an electric grill 500 according to a fifth embodiment of the present invention. In this embodiment, the grill 500 is formed from a sheet of material, such as a metal sheet, that has been machined to produce a grate structure. In one embodiment, the sheet is a steel sheet, such as a 400 series stainless steel sheet, that has been machined by stamping the sheet to provide the grate structure. FIG. 6 is a top plan view of the grill 500, which includes a generally flat portion 510 extending around the edges of the grill and a series of parallel raised ridges 520 extending through the central area of the grill 500. The grill 500 can include open spaces 530 between the ridges 520 that allow fat and grease from a food product on the grill 500 to fall below the grill 500.

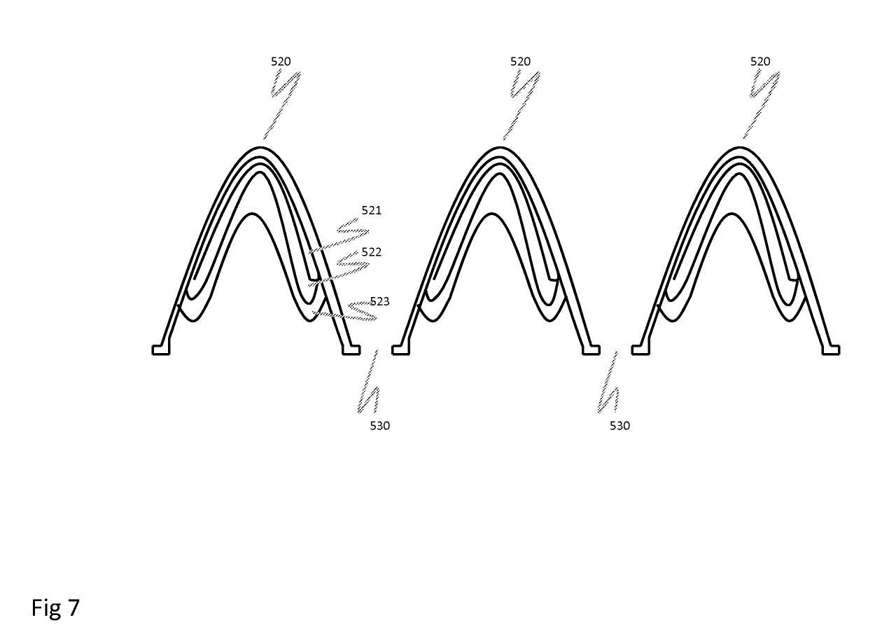

FIG. 7 is a cross section view of a plurality of ridges 520 separated by open spaces 530. In this embodiment, the ridges are relatively closely-spaced (e.g., about 3/16^{th} of an inch apart), but it will be understood that the ridges can have any suitable spacing. The ridges 520 in this embodiment have an inverted “U” or “V” shape. On the underside of each ridge 520 is a layered heating element that includes a first insulating layer 521 located on the underside of the ridge 520, a heater layer 522 on the first insulating layer 521 opposite the ridge 520, and a second insulating layer 523 on the heater layer 521 opposite the ridge 520. Heat flows up from the heater layer 522 through the first insulating layer 521 and the ridge 520 to heat a food item on the grill 500. The grill 500 according to this embodiment can be made from a relatively thin metal sheet. The machined sheet can have any suitable thickness, and can have a thickness of, for example, ½ inch or less, ¼ inch or less, ⅛ inch or less, 1/16 inch or less, or 1/32 inch or less. In one embodiment, the machined sheet has a thickness of between about 0.005 and 0.100 inches, and can be, for example, about 0.028 inches thick.

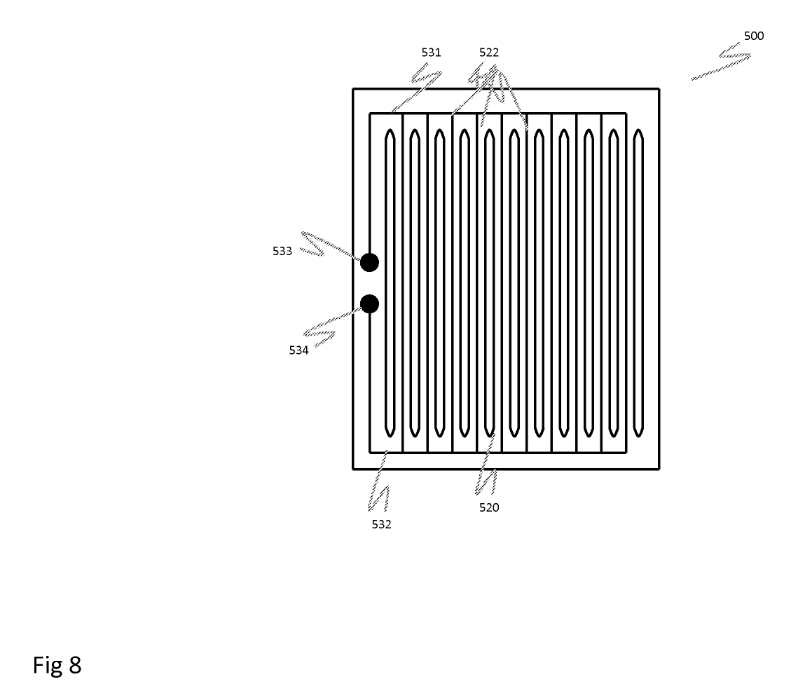

FIG. 8 is a plan view illustrating the underside of the grill 500 of FIGS. 6 and 7. The heater layers 522 are located on the underside of the parallel ridges 520. A pair of electrical conductors, which can be conductive traces 531, 532, extend along opposing edges of the grill 500, and connect each of the heater layers 522 in a parallel circuit configuration. This parallel circuit configuration is advantageous in that the failure of one heating element will not cause the entire grill to fail. In the embodiment of FIG. 8, each of the conductive traces 531, 532 terminates at a respective electrical connector 533, 534. The connectors 533, 534 can be located adjacent to one another, such as shown in FIG. 8, to allow the grill 500 to be easily connected to a power source. The conductive traces 531, 532 can comprise any suitable conductor, such as a wire or ribbon, or can comprise a coating of a conductive material that can be deposited on the grill 500 by a suitable process, such as by spraying or screen printing.

The layered heating element can be encapsulated in a protective layer to protect the heating element from environmental damage and to provide electrical insulation. The protective layer can provide a waterproof seal, and the grill 500 can be dishwasher-safe. The second insulating layer 523 can serve as the protective layer, or one or more additional layers can be provided over the second insulating layer 523 to provide the protective layer. In one embodiment, the protective layer can be a silicone material. Silicones constitute a class of materials that offer desirable engineering properties for layered heaters. Silicones can resist temperature extremes, moisture, corrosion, electrical discharge and weathering. Silicone materials also offer additional advantages for coatings applications. For example, they can be applied using inexpensive processes such as spray painting, dipping and brushing, and they can be cured using belt ovens operating at low temperatures. In one embodiment, both the first insulating layer 521 and the second insulating layer 523, which also serves as the protective layer, are comprised of silicone materials.

It has been found that despite having a relatively small thermal mass, the heating element in this thin-sheet embodiment is able to provide the requisite power for grilling food. By selecting the appropriate heater geometry and resistivity for the heater layer, the grill 500 can easily heat to and sustain cooking temperatures of 500-600 degrees Fahrenheit using conventional household power (e.g., 100-240 V).

In an alternative to the embodiment of FIGS. 6-8, the first insulating layer 521, the heater layer 522 and the third insulating layer 523 can be located on the top side of the ridges 520, similar to the embodiment of FIGS. 2A and 2B.

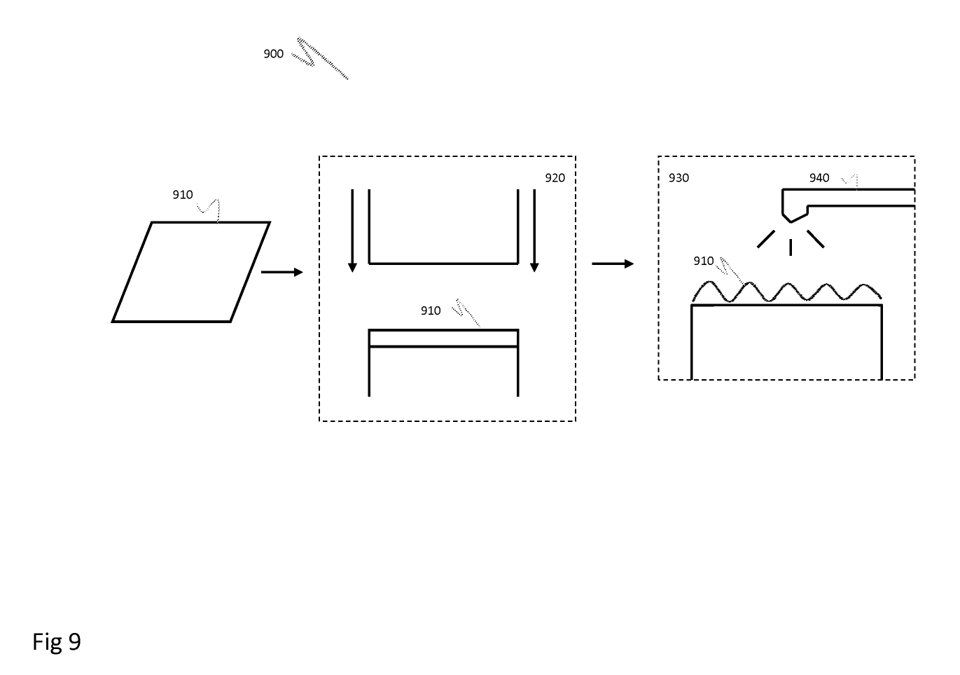

FIG. 9 illustrates a system 900 and method for manufacturing an electric grill 500 according to an embodiment of the invention. A metal sheet 910, which can be a 400 series stainless steel sheet, is cut to the appropriate size, if necessary, and is then fed to a stamping press 920 that is configured to deform and/or cut the metal sheet 910 into the shape of the grill 500 in one or more stages. The sheet 910 is then fed to a processing station 930 for providing various coatings to the underside of the metal sheet 910 to produce an electric grill 500. As shown in FIGS. 7 and 8, for example, heating elements 522 and conductive traces 531, 532 can be provided in a desired pattern on the underside of the metal sheet 910. The processing station 930 can comprise one or more work areas having appropriate equipment for providing various coatings to the sheet 910 in the appropriate sequence and patterns to produce the grill 500.

As previously discussed, a layered heating element can be provided as one or more coatings provided on the metal sheet substrate, and can be provided on the substrate using any known technique, such as thermal spray, kinetic or cold spray, thick film printing and deposition, chemical vapor deposition, evaporation, sputtering, kinetic spray, spray painting, dipping, brushing, laminating, and combinations of the same. In one embodiment, the resistive heating layer 522 (FIG. 7) is deposited by thermal spray, and the processing station 930 includes one or more thermal spray devices 940 (also known as spray “guns”). In certain embodiments, the first insulating layer 521 and the second insulating layer 523 (FIG. 7) can also be formed by thermal spray. In other embodiments, one of both of the insulating layers 521, 523 are formed by a different technique, such as by spray painting, dipping or brushing a silicone material onto the metal sheet 910.

The spray device 940 can be an arc wire thermal spray system, which operates by melting the tips of two wires (e.g., zinc, copper, aluminum, or other metal) and transporting the resulting molten droplets by means of a carrier gas (e.g., compressed air) to the surface to be coated. The wire feedstock is melted by an electric arc generated by a potential difference between the two wires. The spray gun is arranged above the substrate 910. The wire feedstock can be supplied to the spray gun by a feeder mechanism that controls the rate at which the feedstock material is supplied to the gun. The carrier gas is forced through a nozzle in the spray gun and transports the molten droplets at high velocity to the substrate 910 to produce the heating layer 522. The carrier gas can be supplied by one or more pressurized gas sources. In a preferred embodiment, the carrier gas includes at least one reactant gas that reacts with the molten droplets to control the resistivity of the deposited layer. The reactant gas can be, for example, an oxygen, nitrogen, carbon or boron-containing gas that reacts with the metallic material in the molten droplets to provide a reaction product that can increase the resistivity of the deposited layer relative to the resistivity of the feedstock material. The spray gun can be translated relative to the substrate 910 in order to build up a coating layer over multiple passes. The gun 21 can be attached to a motion control system such as a linear translator or multi-axis robot. A control system, preferably a computerized control system, can control the operation of the spray gun.

Other known spray techniques can be used in the present invention to deposit the film heater layer, including arc plasma spray systems, flame spray systems, high-velocity oxygen fuel (HVOF) systems, and kinetic, or “cold” spray systems.

The conductive traces 531, 532 (FIG. 8) can also be formed by spraying a conductive material onto the sheet 910 in the appropriate pattern. Alternatively, the conductive traces 531, 532 can be formed by depositing a conductive material using another technique, such by as screen printing. After the heating layer(s) 522 and conductive traces 531, 532 have been applied to the sheet 910, a protective layer of an insulating material, such as silicone, can be applied to insulate and protect the electronic components of the grill 500.

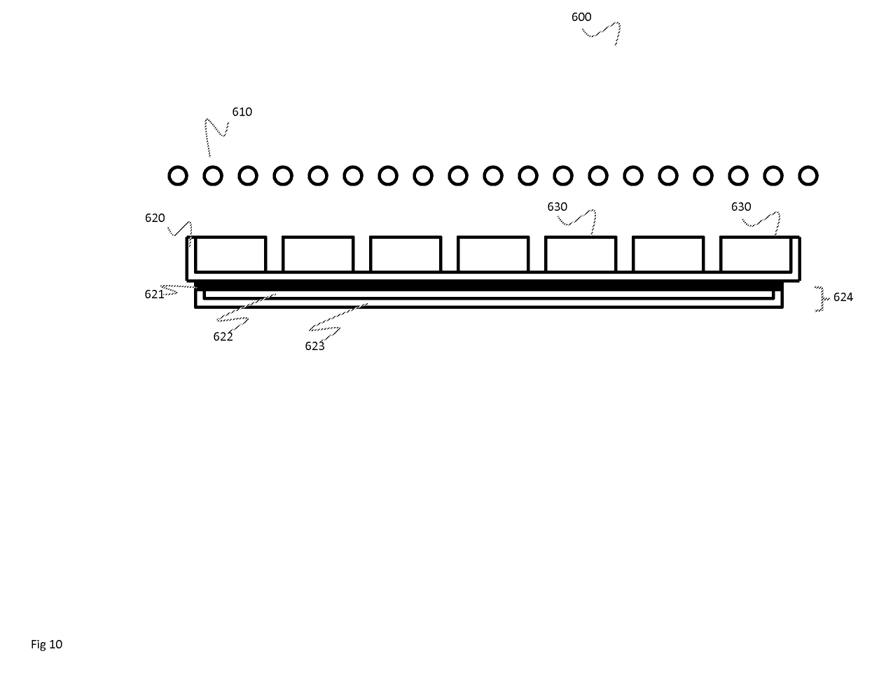

FIG. 10 illustrates an electric grill 600 according to a sixth embodiment of the invention. In this embodiment, the grill 600 includes a cooking grate 610, which can be any conventional grill cooking surface, and a supporting tray 620 located beneath the grate 610, and holding a plurality of ceramic tiles or briquettes 630. A layered heating element 624, which can comprise a first insulating layer 621, a resistive heating layer 622, and a second insulating overcoat 623, such as described above in connection with FIGS. 1-9, is provided on at least one surface of the supporting tray 620. In the embodiment of FIG. 10, the layered heating element 624 is provided on the bottom surface of the tray 620, though it will be understood that the heating element can be provided on any surface(s) of the tray 620. When the heating element 624 is electrically energized, heat from the heating layer 622 is conducted to the briquettes 630, which, in turn, radiate heat upwards to the food positioned on the grate 610. The briquettes 630 can also evaporate grease and other secretions that drip down from the food. It will be understood that in addition to ceramic briquettes, other suitable materials for radiating heat, such as lava rocks, could be positioned on the supporting tray 620. The supporting tray 620 could be a rock grate for holding ceramic briquettes or lava rocks, as is often found in conventional gas grills.

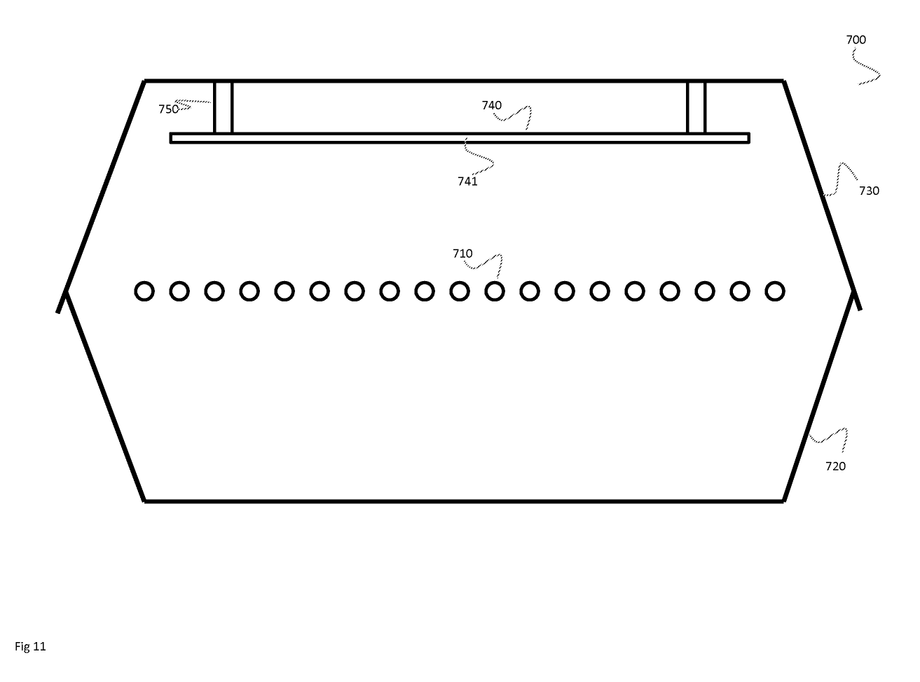

FIG. 11 is a cross-sectional illustration of a grill 700 according to a seventh embodiment of the invention. In this embodiment, the grill 700 includes a cooking grate 710, which can be any conventional grill cooking surface. The grate 710 is positioned on and supported by a bottom grill housing 720. A grill hood 730 can be positioned over the bottom grill housing 720 to provide an enclosed grill cavity. A heater panel 740 is attached to the grill hood 730 and suspended inside the grill cavity. A resistive heating layer 741 is provided on the heater panel 740. The use of a separate heater panel can be advantageous for ease of manufacture, to minimize capacitive leakage currents, and for ease of maintenance and replacement.

The heater panel 740 can be composed of an insulating material, and the resistive heating layer 741 can be deposited as a coating directly onto the panel 740. The resistive film heating layer can be deposited using any of the methods described above in connection with FIGS. 1-10. The panel 740 can comprise mica, which has good dielectric properties, and is relatively low cost. An insulating protective layer can optionally be provided over the resistive heating layer 741. In one embodiment, the panel 740 can comprise a pair of insulative substrates, such as mica substrates, that sandwich a resistive heating layer 741 deposited on one of the substrates.

Where the panel 740 is made of an electrically conductive material, such as a metal, an insulating layer can be provided over the panel surface and the resistive heating layer 741 can be provided over the insulating layer.

A suspended panel 740 can deliver intense radiant heat to food that is positioned on the grate 710. The suspended panel 740 can be particularly advantageous for broiling. The panel 740 can be spaced from an interior wall of the hood 730 by one or more spacers, such as posts 750. One or more panels 740 can be mounted to any interior wall of the hood 730 or the bottom grill housing 720, and spaced away from the wall using suitable spacers.

The heater panel 740 can be the primary heat source for the grill 700. In other embodiments, the grill 700 can include other heat sources in addition to the heater panel 740, such as the electric heat sources as described in connection with FIGS. 1-10, as well as conventional gas or charcoal heat sources.

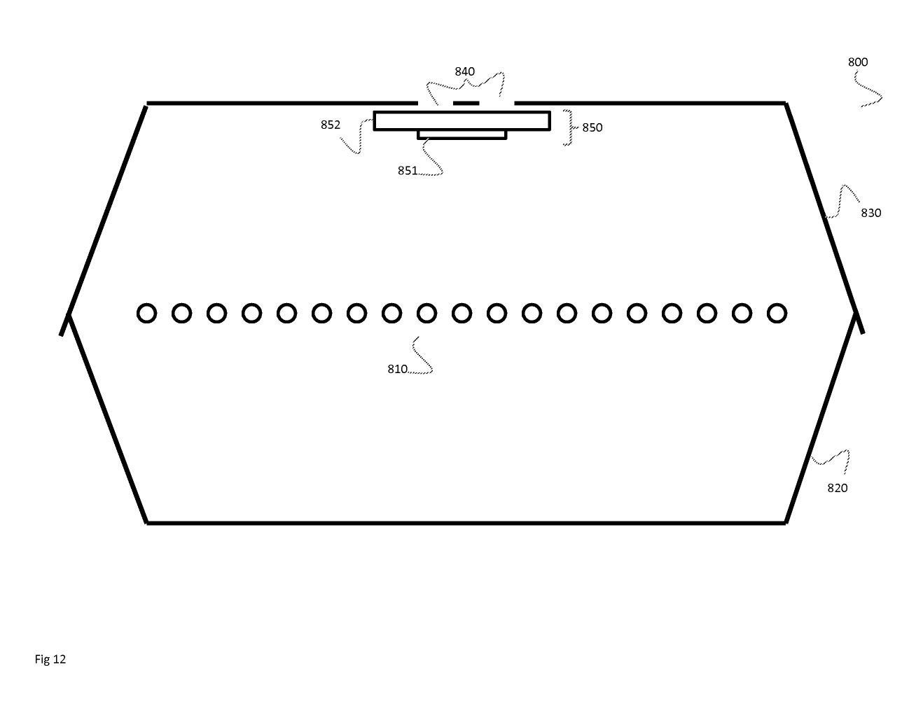

FIG. 12 is a cross-sectional illustration of a grill 800 according to an eighth embodiment of the invention. The grill 800 in this embodiment includes a cooking grate 810, a bottom grill housing 820, and a grill hood 830, similar to the grill 700 of FIG. 11. The grill hood 830 includes a smoke exhaust system 840, which is typically one or more vent holes for venting smoke and fumes from the grill 800, and an odor-removal device 850 that is cooperatively associated with the exhaust system 840. The odor-removal device 850 is positioned so that most or all of the smoke generated by the grill 800 passes through the odor-removal device 850 for removal of contaminants before the treated smoke is exhausted to the environment through the exhaust system 840.

It is well-known that barbeque grills produce undesirable smoke emissions, including undesirable contaminants such as vaporized grease droppings, that are malodorous, potentially dangerous, and have greatly inhibited the widespread use of barbeque grills indoors or in other enclosed spaces. Accordingly, the odor-removal device 850 is provided to treat the smoke emissions from the grilling process, such as by catalytic conversion, in order to break down the complex organic contaminants into simpler molecules and thereby minimize the emission of foul odors from the grill 800.

In one embodiment, the odor-removal device 850 includes a catalyst material 852 and a layered heater 851 that is in thermal communication with the catalyst material 852. The catalyst material 852 acts upon the cooking emissions to break down complex organic molecules and reduce odors. The layered heater 851 heats the catalyst material 852 to a temperature sufficient to support a catalytic reaction.

In one embodiment, the catalyst material 852 is a layered metallic substrate coated with a high surface area aluminum oxide coating that has been impregnated with catalytically active elements. The substrate is processed to provide a plurality of channels through the substrate through which the smoke from the grill can flow. The catalytically active elements can be one or more elements from the platinum group metal series. The catalytically active elements act upon emissions from the cooking process to break them down into simpler forms. It will be understood that in addition to the layered metallic substrate, other substrate materials for supporting catalytically active elements can be used, such as a honeycomb structure, wire mesh, expanded metal, metal foam or ceramics. Also, other materials besides elements from the platinum group metal series, such as elements from Groups IVA to IIB of the periodic table, can be used as catalytically active elements.

Exemplary embodiments of catalyst materials 852 suitable for use in the present invention are described in U.S. Published Application No. 2009/0050129 to Robinson, Jr., the entire teachings of which are incorporated by reference herein.

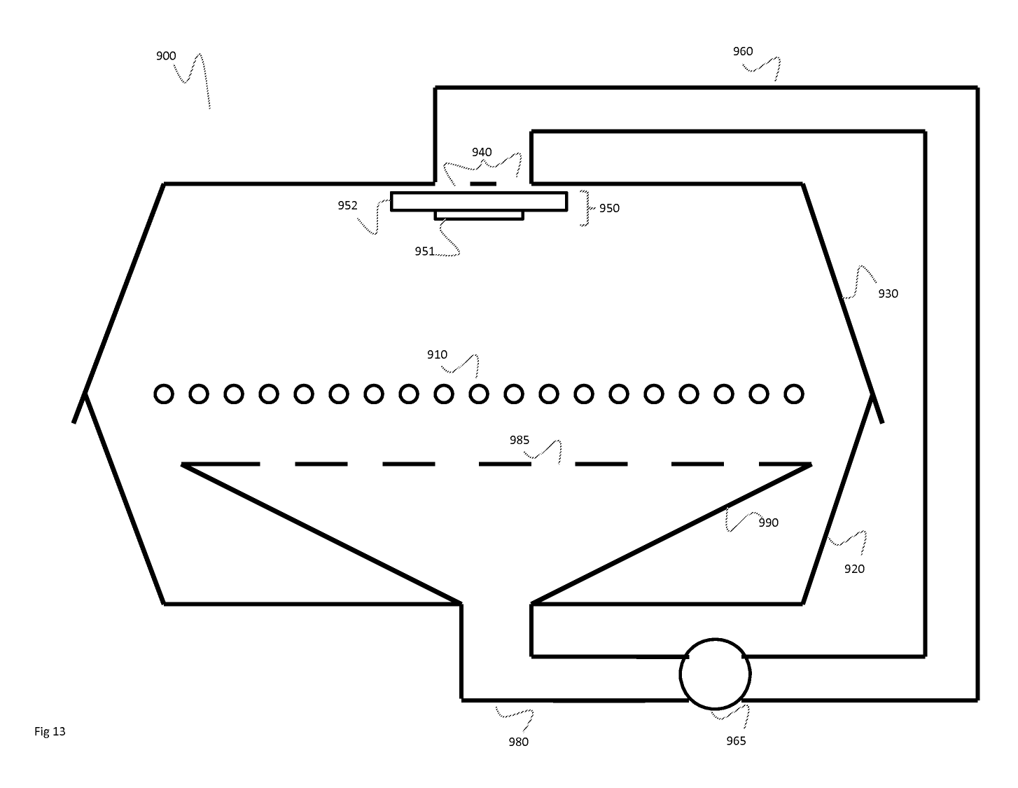

FIG. 13 is a cross-sectional illustration of a grill 1000 according to a ninth embodiment of the invention. The grill 1000 in this embodiment includes a cooking grate 1010, a bottom grill housing 1020, and a grill hood 1030, similar to the grill 700 of FIG. 11 and the grill 800 of FIG. 12. The grill hood 1030 includes a smoke exhaust system 1040 similar to the smoke exhaust system 840 of FIG. 11, which is typically one or more vent holes for venting smoke and fumes from the grill 1000, and an odor-removal device 1050 that is cooperatively associated with the exhaust system 1040. The odor-removal device 1050, similar to the odor-removal device 850 of FIG. 11, is positioned so that most or all of the smoke generated by the grill 1000 passes through the odor-removal device 1050 for removal of contaminants before the cleaned smoke is exhausted to a pipe 1060 that is coupled to a blower 1065. The output of the blower 1065 is coupled to a second pipe 1080 that is coupled with the grill housing 1020 on the bottom, back or side. The second pipe 1080 carries the treated heated smoke that is re-circulated in the grill 1000 to provide convection heat via a plenum 1090 with diffuser holes 1085.

Optionally the blower can be covered with a resistive heater surface to control the heat of the treated smoke re-circulated into the grill 1000.

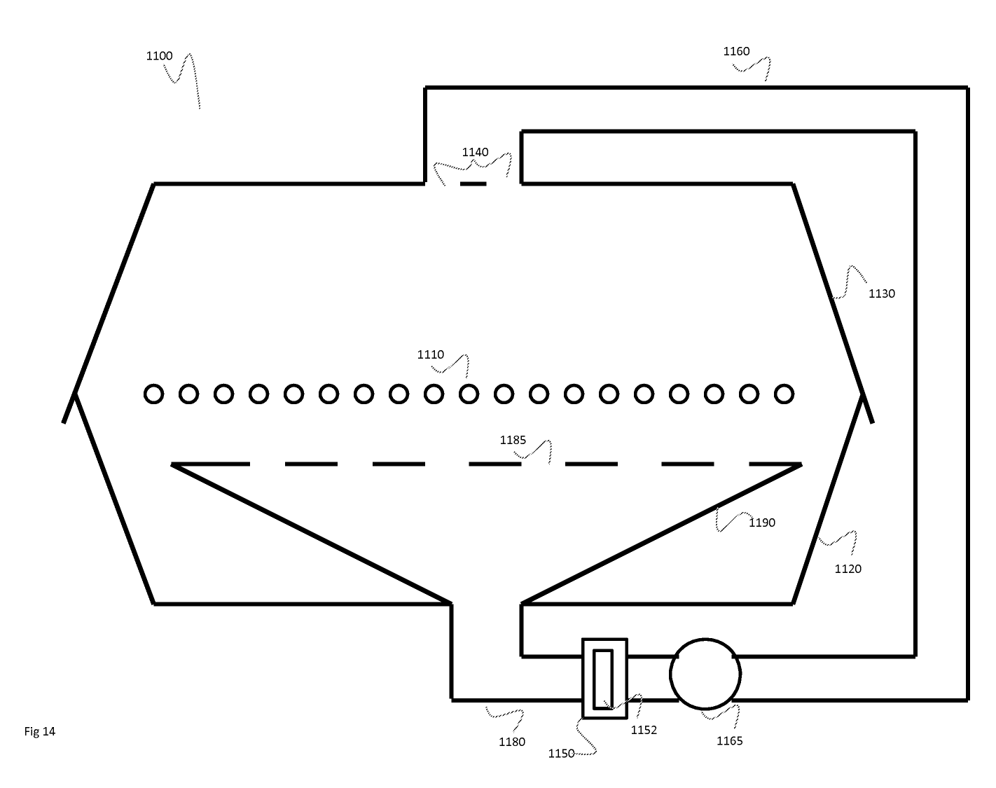

FIG. 14 is a cross-sectional illustration of a grill 1100 according to a ninth embodiment of the invention. The grill 1100 in this embodiment includes a cooking grate 1110, a bottom grill housing 1120, and a grill hood 1130, similar to the grill 700 of FIG. 11 and the grill 800 of FIG. 12. The grill hood 1130 includes a smoke exhaust system 1140 similar to the smoke exhaust system 840 of FIG. 11, which is typically one or more vent holes for venting smoke and fumes from the grill 1100 into a re-circulating pipe 1160. The pipe 1160 is coupled to a blower 1165, which is in turn coupled to an odor-removal device 1150, similar to the odor-removal device 850 of FIG. 11. The odor-removal device is positioned so that most or all of the smoke re-circulated by the blower 1165 passes through the odor-removal device 1150 for removal of contaminants before the treated smoke returned into the grill 1100 through a second pipe 1180 that is coupled with the grill housing 1020 on the bottom, back or side. The second pipe 1180 carries clean, heated air that is re-circulated by the blower 1165 in the grill 1000 to provide convection heat via a plenum 1190 with diffuser holes 1185. Optionally the blower can be covered with a resistive heater surface to control the heat of the treated smoke re-circulated into the grill 1100.

The layered heater 851 is formed as a coating, and can comprise, for example, a deposited resistive film heating layer using techniques discussed above in relation to FIG. 5. The layered heater 851 can be provided in close proximity to the catalyst material 852, and transfers heat to the catalyst material 852 through conductive, radiative or convective heat transfer processes, or through a combination of these processes. For example, the layered heater 851 can be deposited directly on the catalyst material 852 or on a tray or other support upon which the catalyst material 852 is supported for maximum conductive heat transfer. The layered heater 851 can be spaced away from the catalyst material 852, such as on a separate panel that faces the catalyst material 852 and provides radiant heating to the catalyst material 852. The heater layer 851 can also be positioned within a duct or other gas conduit, upstream of the catalyst material 852, and can heat the smoke emanating from the grill to a temperature sufficient to support catalytic reaction at the catalyst material 852. In some embodiments, the heater layer 851 can heat the smoke to a temperature sufficient to oxidize the carbon contaminants in the smoke without the use of an expensive precious metal catalyst material.

It will be understood that the odor-removal device 850 can be advantageously utilized with any of the electric grill embodiments as described in connection with FIGS. 1-11, as well as with any conventional gas or charcoal grills.

In general, the heater layers in any of the embodiments of the present invention can be designed with knowledge of the applied voltage and power desired. From these quantities, a necessary resistance is calculated. Knowing the resistance and the material resistivity, the dimensions of the heater layers, or an element containing a heater layer, can then be determined. Depending on the deposition technique, the material resistivity can be modified to optimize the design. It should be noted that the heater layers or element containing a heater layer, may be shaped many different ways so as to provide heating in accordance with a required heating pattern.

There are many advantages to using a heater layer provided as a coating in accordance with the present invention including, but not limited to: the heater coating occupying almost no space and having almost no mass, thereby allowing a compact design and adding to thermal efficiency since the heater coating does not require energy to heat up; the heater coating being typically well bonded to a part, or substrate, that it is deposited on, thereby maintaining very little impedance to the flow of heat to that part (i.e., increased thermal efficiency); the heater coating distributing power over an area it covers; the heater coating having the capability of distributing power nonuniformly over its surface to compensate for edge losses, thereby providing uniform temperature distributions over a grilling surface; and, the heater coating being amenable to common manufacturing methods where cost and volume are important.

Examples of resistive heater coating layers and methods for the fabrication of heating elements, and various applications for heater coating layers, are described in commonly-owned U.S. Pat. Nos. 7,482,556, 6,762,396, 6,919,543, and 6,294,468, in commonly-owned U.S. Published Patent Applications Nos. 2003/0121906 A1, and 2008/0217324 A1, in U.S. patent application Ser. Nos. 12/434,353, filed on May 1, 2009, and 12/156,438, filed on May 30, 2008, and in International Application No. PCT/US2009/45702, filed on May 29, 2009. The entire teachings of the above-referenced patents and patent applications are incorporated herein by reference.

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

1. A method of fabricating an electric grill having a grate that comprises a structure for supporting food on said grate and for draining liquid from said food, the method comprising:
depositing a film heater layer on an electrical insulator to provide a heating element, the heating element being in thermal communication with the grate.

2-5. (canceled)

6. An electric grill, comprising:
a grate;
a heat shield positioned below the grate; and
a film heater layer over a surface of the heat shield.

7-10. (canceled)

11. A kit for converting a gas grill into an electric grill, comprising:
a heat shield for positioning below a cooking surface;
a film heater layer over a surface of the heat shield; and
an apparatus for connecting the film heater layer to an electrical power source.

12. An electric grill, comprising:
a metal sheet that is shaped to provide a structure for supporting food on the sheet and for draining liquid from the food; and
an electrically resistive heater layer over a surface of the metal sheet.

13-23. (canceled)

24. An electric grill, comprising:
a grate;
a support tray for holding at least one of ceramic tiles and briquettes that is positioned below the grate; and
a film heater layer over a surface of the support tray.

25-28. (canceled)

29. An electric grill, comprising:
a lower grill housing;
a grate supported on the lower grill housing;
a hood positionable over the lower grill housing to provide an enclosed grill cavity; and
a heater panel mounted to an interior surface of the hood, the heater panel comprising a substrate and a film heater layer over a surface of the substrate.

30-36. (canceled)

37. A grill, comprising:
a lower grill housing;
a grate supported on the lower grill housing;
a hood positionable over the lower grill housing to provide an enclosed grill cavity; a smoke exhaust system for venting a cleaned smoke and fumes from the enclosed grill cavity to the environment; and
an odor-removal device that is cooperatively associated the exhaust system for removing odors and contaminants from the grill smoke before the smoke is vented to the environment, the odor removal device comprising a film heater layer.

38-47. (canceled)

48. A method of fabricating an electric grill having a grate comprising a structure for supporting food on said grate and for draining liquid from said food, and a heat shield below the grate, the method comprising:
providing a heater layer over a surface of the heat shield.

49-51. (canceled)

52. A method of fabricating an electric grill, comprising:
providing a metal sheet that is shaped to provide a structure for supporting food on the sheet and for draining liquid from the food; and
providing an electrically resistive heater layer over a surface of the metal sheet.

53-62. (canceled)

63. A method of fabricating an electric grill having a grate and a support tray for holding at least one of ceramic tiles and briquettes that is positioned below the grate, the method comprising:
providing a heater layer over a surface of the support tray.

64-66. (canceled)

67. A method of fabricating an electric grill having a lower grill housing, a grate supported on the lower grill housing, and a hood positionable over the lower grill housing to provide an enclosed grill cavity, the method comprising:
providing a heater panel mounted to an interior surface of the hood, the heater panel comprising a substrate; and
providing a film heater layer over a surface of the substrate.

68-73. (canceled)

74. A method of fabricating a grill having a lower grill housing, a grate supported on the lower grill housing, a hood positionable over the lower grill housing to provide an enclosed grill cavity and a smoke exhaust system for venting smoke and fumes from the enclosed grill cavity to the environment, the method comprising:
providing an odor-removal device that is cooperatively associated the exhaust system for removing odors and contaminants from the grill smoke before a treated smoke is vented to the environment; and
providing a film heater layer on the odor-removal device.

75-84. (canceled)
